(19) United States
(12) Patent Application Publication
(10) Pub. No.: US 2018/0121322 A1
(43) Pub. Date: May 3, 2018

(54) Methods and Systems for Testing Versions of Applications

(71) Applicant: FACEBOOK, INC., Menlo Park, CA (US)

(72) Inventors: James L. Reyes, Sunnyvale, CA (US); Ron Aldwin Chua Yu, Mountain View, CA (US); Sarah Edge Mann, Menlo Park, CA (US)

(21) Appl. No.: 15/348,830

(22) Filed: Nov. 10, 2016

Related U.S. Application Data
(60) Provisional application No. 62/415,408, filed on Oct. 31, 2016.

(51) Int. Cl. G06F 11/36; G06F 9/44

(52) U.S. Cl. CPC G06F 11/3616; H04L 67/42; G06F 11/3692; G06F 8/71

(57) ABSTRACT

A server system receives, from client devices, a first plurality of messages associated with user actions in a first version of an application. The first plurality of messages includes performance indicators relating to the first version. The method further includes receiving, from client devices, a second plurality of messages associated with user actions in a second version of an application. The second plurality of messages includes performance indicators relating to the second version. The second version of the application is more recent than the first version of the application. Subsequently, compare the performance indicators relating to the first version of the application with the performance indicators relating to the second version of the application. In response to a determination that a difference between a respective performance indicator in the first version and the second version satisfies a threshold value, provide a report of the respective performance indicator.

### RELATED APPLICATION

This application claims priority and benefit to U.S. Provisional Application No. 62/415,408, filed Oct. 31, 2016, entitled “Methods and Systems for Testing Versions of Applications,” which is hereby incorporated by reference in its entirety.

### TECHNICAL FIELD

This relates generally to application testing, including but not limited to testing an updated (e.g., new) version of an application.

### BACKGROUND

Software applications provide a convenient means to access various platforms. Introducing an updated (e.g., new) version of the software application, however, typically involves testing portions of the software application. This process is expensive and inefficient, and subject to both human and machine-based inaccuracies.

### SUMMARY

Accordingly, there is a need for methods and systems for efficiently testing updated versions of applications. Comparing performance data from different versions of the application can greatly improve application testing efficiency. Such methods and systems optionally provide application developers with information concerning faulty aspects of the software application.

In accordance with some embodiments, a method is performed at a server system having processors and memory storing instructions for execution by the processors. The method includes receiving, from one or more client devices, a first plurality of messages associated with user actions in a first version of an application. The first plurality of messages includes performance indicators relating to the first version of the application. The method further includes receiving, from one or more client devices, a second plurality of messages associated with user actions in a second version of an application. The second plurality of messages includes performance indicators relating to the second version of the application. Moreover, the second version of the application is more recent than the first version of the application. After receiving the first and second pluralities of messages, the method includes comparing the performance indicators relating to the first version of the application with the performance indicators relating to the second version of the application. In response to a determination that a difference between a respective performance indicator in the first version and the second version satisfies a threshold value, the method includes providing a report of the respective performance indicator.

In accordance with some embodiments, a server system includes one or more processors/cores, memory, and one or more programs; the one or more programs are stored in the memory and configured to be executed by the one or more processors/cores and the one or more programs include instructions for performing the operations of the method described above. In accordance with some embodiments, a computer-readable storage medium has stored therein instructions which when executed by one or more processors/cores of a server system, cause the server system to perform the operations of the method described above.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an exemplary network architecture of a social network in accordance with some embodiments.

FIG. 2 is a block diagram illustrating an exemplary server system in accordance with some embodiments.

FIG. 3 is a block diagram illustrating an exemplary compare operation in accordance with some embodiments.

FIG. 4 is an illustration of a report provided by the server system, in accordance with some embodiments.

FIGS. 5A-5C are flow diagrams illustrating a method of comparing performance data from two versions of an application, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first version could be termed a second version, and, similarly, a second version could be termed a first version, without departing from the scope of the various described embodiments. The first version and the second version are both versions, but they are not the same version.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

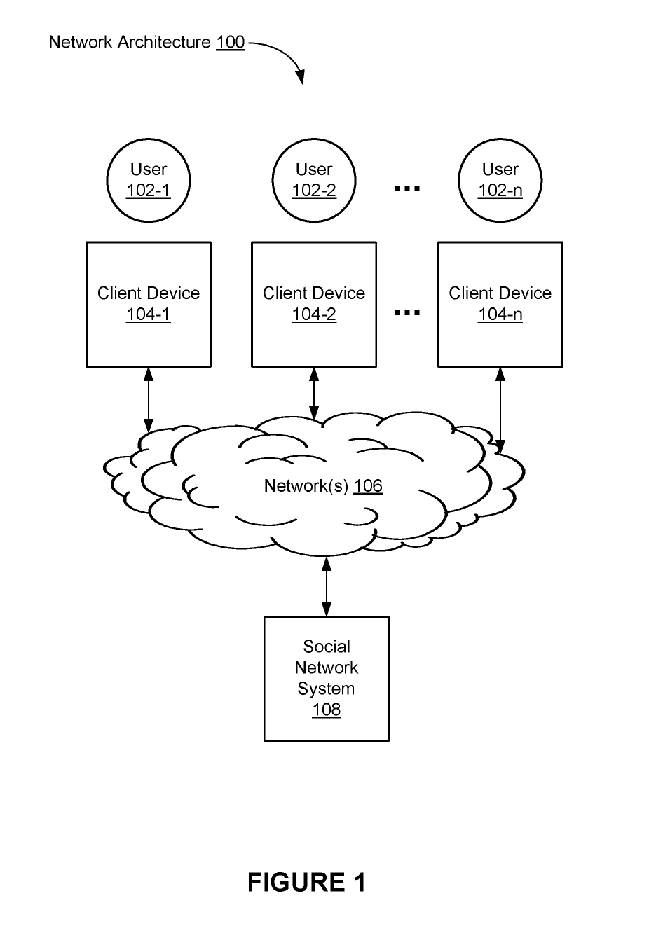

FIG. 1 is a block diagram illustrating an exemplary network architecture of a social network in accordance with some embodiments. The network architecture 100 includes a number of client devices (also called “client systems,” “client computers,” or “clients”) 104-1, 104-2, . . . 104-n communicably connected to a social network system 108 by one or more networks 106.

In some embodiments, the client devices 104-1, 104-2, . . . 104-n are computing devices such as smart watches, personal digital assistants, portable media players, smart phones, tablet computers, 2D gaming devices, 3D gaming devices, virtual reality devices, laptop computers, desktop computers, televisions with one or more processors embedded therein or coupled thereto, in-vehicle information systems (e.g., an in-car computer system that provides navigation, entertainment, and/or other information), or other appropriate computing devices that can be used to communicate with an electronic social network system and other computing devices (e.g., via the electronic social network system). In some embodiments, the social network system 108 is a single computing device such as a computer server, while in other embodiments, the social network system 108 is implemented by multiple computing devices working together to perform the actions of a server system (e.g., cloud computing). In some embodiments, the network 106 is a public communication network (e.g., the Internet or a cellular data network), a private communications network (e.g., private LAN or leased lines), or a combination of such communication networks.

Users 102-1, 102-2, . . . 102-n employ the client devices 104-1, 104-2, . . . 104-n to access the social network system 108 and to participate in a social networking service. For example, one or more of the client devices 104-1, 104-2, . . . 104-n execute web browser applications that can be used to access the social networking service. As another example, one or more of the client devices 104-1, 104-2, . . . 104-n execute software applications that are specific to the one or more social networks (e.g., social networking “apps” running on smart phones or tablets, such as a Facebook social networking application, a messaging application, etc., running on an iPhone, Android, or Windows smart phone or tablet).

Users interacting with the client devices 104-1, 104-2, . . . 104-n can participate in the social networking service provided by the social network system 108 by providing and/or consuming (e.g., posting, writing, viewing, publishing, broadcasting, promoting, recommending, sharing) information, such as text comments (e.g., statuses, updates, announcements, replies, location “check-ins,” private/group messages), digital content (e.g., photos, videos, audio files, links, documents), and/or other electronic content. In some embodiments, users provide information to a page, group, message board, feed, and/or user profile of a social networking service provided by the social network system 108. Users of the social networking service can also annotate information posted by other users of the social networking service (e.g., endorsing or “liking” a posting of another user, or commenting on a posting by another user). In some embodiments, information can be posted on a user's behalf by systems and/or services external to the social network or the social network system 108. For example, the user may post a review of a movie to a movie review website, and with proper permissions that website may cross-post the review to the social network on the user's behalf. In another example, a software application executing on a mobile client device, with proper permissions, may use global positioning system (GPS) or other geo-location capabilities (e.g., Wi-Fi or hybrid positioning systems) to determine the user's location and update the social network with the user's location (e.g., “At Home,” “At Work,” or “In San Francisco, Calif.”), and/or update the social network with information derived from and/or based on the user's location. Users interacting with the client devices 104-1, 104-2, . . . 104-n can also use the social network provided by the social network system 108 to define groups of users. Users interacting with the client devices 104-1, 104-2, . . . 104-n can also use the social network provided by the social network system 108 to communicate (e.g., using a messaging application or built-in feature) and collaborate with each other.

In some embodiments, a first group of client devices (e.g., client devices 104-1-104-k) execute a software application (also referred to as an application) that is different in some aspect from a software application being executed by a second group of client devices (e.g., client devices 104-k-104-n). For example, the software application may be a different version (e.g., client devices 104-1-104-k execute version X of the Facebook social networking application while client devices 104-1-104-n execute version Y of the Facebook social networking application). In some embodiments, a second group of client devices is a group that tests an updated (e.g., new) software application (e.g., version Y of the Facebook for Android social networking application is released for beta testing). Alternatively, in some embodiments, the first group of client devices is the same as the second group of client devices. For example, the first and second groups of client devices may be designated “beta testers” for updated software applications for a software developer.

In order to obtain information with respect to the performance of the updated application, the social network system 108 first receives messages from a first group of client devices. The first group of client devices sends messages containing one or more performance indicators for an application to the social network system 108 via the one or more network 106. In some embodiments, the application is a previously released application.

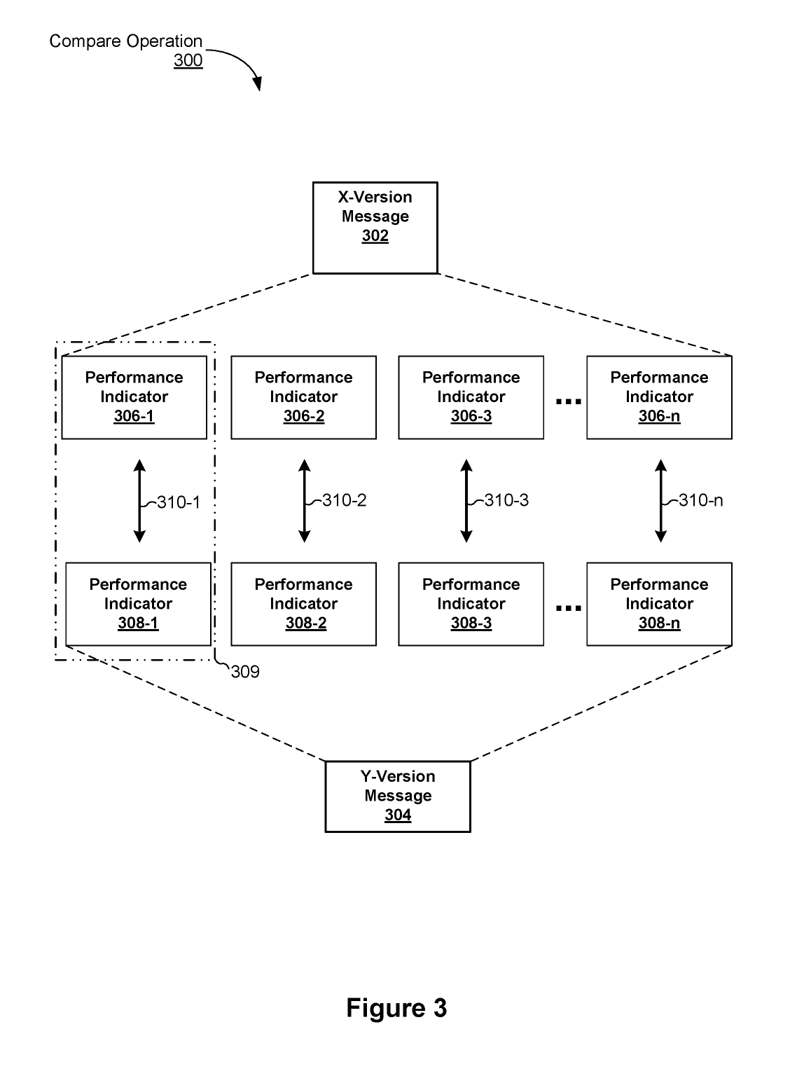

A performance indicator includes performance data relating to specific application programs. For example, if a client device (e.g., client devices 104-1, 104-2, . . . 104-n) executing the application uses a video streaming portion of the application, the client device may send the social network system 108 a message containing data relating to the performance of the video streaming portion of the application (e.g., X-version message 302 contains performance indicators 306-1, 306-2, 306-3, . . . 306-n, FIG. 3). Subsequently, the social network system 108 may extract the performance data from the received messages, and form one or more baselines relating to each specific application program. The one or more baselines can create points of reference for each specific application program of the software application. In some embodiments, the received messages are normalized using one or more normalization factors. The one or more normalization factors may include client device model, network type (e.g., second generation wireless (2G), etc.).

A second group of client devices may send messages containing one or more performance indicators for an updated (e.g., new) application to the social network system 108 via the one or more networks 106. For example, if a client device (e.g., client devices 104-1, 104-2, . . . 104-n) executing the application uses a video streaming portion of the updated application, the client device may send the social network system 108 a message containing data relating to the performance of the video streaming portion of the updated application (e.g., Y-version message 304 contains performance indicators 308-1, 308-2, 308-3, . . . 308-n, FIG. 3). Subsequently, the social network system 108 may extract and then compare the data relating to the performance of the video streaming portion of the updated application against the previously gathered data relating to the performance of the video streaming portion of the application for a previous version (e.g., X-version message 302, FIG. 3).

In some embodiments, a message received from one client device in the first or second group of client devices may contain multiple performance indicators (e.g., Y-version message 304 may contain performance indicators 308-1, 308-2, 308-3, . . . 308-n, FIG. 3). Consequently, in some embodiments, a single message may include performance data relating to several portions of the software application.

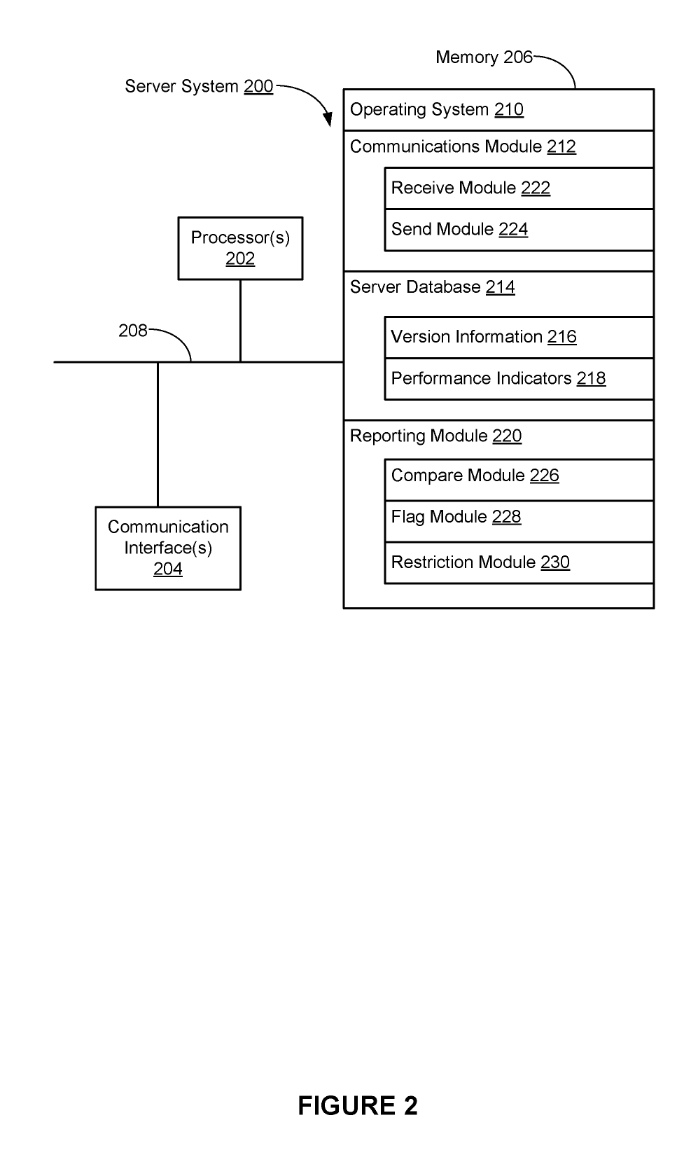

FIG. 2 is a block diagram illustrating an exemplary server system 200 in accordance with some embodiments. In some embodiments, the server system 200 is an example of a social network system 108. The server system 200 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The server system 200 optionally includes a user interface (not shown). The user interface, if provided, may include a display device and optionally includes inputs such as a keyboard, mouse, trackpad, and/or input buttons. Alternatively or in addition, the display device may include a touch-sensitive surface, in which case the display is a touch-sensitive display.

Memory 206 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the processor(s) 202. Memory 206, or alternately the non-volatile memory device(s) within memory 206, includes a non-transitory computer readable storage medium. In some embodiments, memory 206 or the computer readable storage medium of memory 206 stores the following programs, modules and data structures, or a subset or superset thereof:
an operating system 210 that includes procedures for handling various basic system services and for performing hardware dependent tasks;
a network communication module 212 that is used for connecting server system 200 (e.g., social network system 108, FIG. 1) to other computers via the one or more communication network interfaces 204 (wired or wireless) and one or more communication networks, such as the Internet, cellular telephone networks, mobile data networks, other wide area networks, local area networks, metropolitan area networks, and so on;
server database 214 for storing data associated with the server system 200, such as:
   version information 216 (e.g., data for a previously released version of an software application and data for an updated version of the software application); and
   performance indicators 218;
a reporting module 220 for providing a report associated with a respective performance indicator:
   a compare module 226 for comparing a performance indicator from an updated version of a software application with a corresponding performance indicator from a previous version of the software application;
   a flag module 228 for flagging a respective performance indicator that fails in some respect when compared to the corresponding performance indicator from a previous version of the software application; and
   a restriction module 230 for restricting access to an updated (e.g., new) version of the software application to a group of client devices. The restriction module maintains the restriction until one or more conditions are satisfied. In some embodiments, the one or more conditions include: (1) maintaining restricted access for a period of time; (2) maintaining restricted access until a threshold amount of messages are received; and/or (3) maintaining restricted access until each program of the software application is executed a predefined number of times by client devices.

In some embodiments, the network communication module 212 includes a receive module 222. In some embodiments, the receive module 222 is used for receiving messages from one or more client devices via the one or more network(s) 106. In some embodiments, the network communication module 212 includes a send module 224. In some embodiments, the send module 224 is used for sending messages to one or more client devices or one or more third party servers via the one or more network(s) 106.

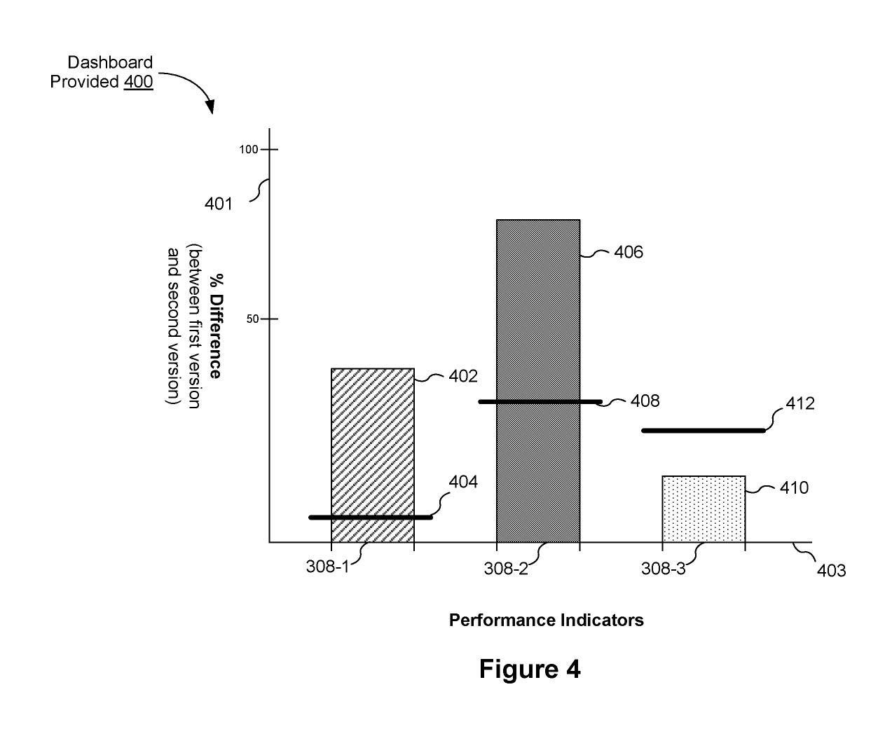

In some embodiments, the reporting module 220 determines a threshold (e.g., permissible deviation from a baseline, such as baseline 403, FIG. 4) for each respective performance indicator. For example, the reporting module 220 may make the determination by analyzing performance data from previous versions of the software application, along with expected variations resulting from updates features (e.g., one or more changes) in the updated version of the application.

The server database 214 may additionally store data associated with the server system 200 in one or more types of databases, such as graph, dimensional, flat, hierarchical, network, object-oriented, relational, and/or XML databases. In some embodiments, the server database 214 includes a graph database. The graph database includes one or more graphs that can be provided.

In some embodiments, the server system 200 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

FIG. 3 is a block diagram illustrating an exemplary compare operation 300, in accordance with some embodiments. In particular, a server system (e.g., server system 200, FIG. 2, or a component thereof such as compare module 226, FIG. 2) may compare content from X-version message 302 (e.g., performance indicators 306-1, 306-2, 306-3, . . . 306-n) with content from Y-version message 304 (e.g., performance indicators 308-1, 308-2, 308-3, . . . 308-n). The server system 200 may receive the X-version message 302 from a client device (e.g., client device 104-1, 104-2, . . . 104-n, FIG. 1) and store the content of the message 302 in memory (e.g., memory 206, FIG. 2). Furthermore, the server system 200 may receive the Y-version message 304 from a client device (e.g., client device 104-1, 104-2, . . . 104-n, FIG. 1) and also store the contents of the message 304 in memory. In some embodiments, the server system 200 may update a table with the content from the first and second messages or store the content from the first and second messages by other means known in the art. For ease of reference, “X-version” refers to a previous version of an application (e.g., a social media application) and “Y-version” refers to an updated (e.g., new) version of the application (e.g., a more recent version of the social media application).

Although FIG. 3 shows the contents of a single X-version message 302 being compared with the contents of a single Y-version message 304, in some embodiments, the server system 200 compares the contents of multiple X-version messages 302 with the contents of multiple Y-version messages 304. As such, in some embodiments, the server system 200 receives and stores in memory (e.g., stores in version information 216, FIG. 2) multiple X-version and Y-version messages.

In some embodiments, the X-version message 302 includes a single performance indicator (e.g., performance indicator 306-1). Alternatively, in some embodiments, the X-version message 302 may include a plurality of performance indicators (e.g., performance indicators 306-1, 306-2, 306-3, . . . 306-n). Each performance indicator is associated with an application program of the software application. For example, performance indicator 306-1 may correspond to a video streaming program of the application. Furthermore, each performance indicator may include performance data (also referred to herein as usage statistics) for its application program. For example, performance indicator 306-1 may include performance data for the video streaming program in the application. The performance data corresponding to a given program (e.g., an application event) in the application is generated when the application, executing on the client device, performs the program (e.g., the application, executing on the client device, streams a video). The performance indicator may also include other data such as application version, application type (e.g., iOS, Android, and the like), Internet Protocol address (IP address), and the like.

In some embodiments, the performance data for the performance indicators 306-1, 306-2, 306-3, . . . 306-n are averages determined from multiple X-version messages 302. More specifically, the server system may average performance data relating to each performance indicator (e.g., performance indicators 306-1, 306-2, 306-3, . . . 306-n) received in multiple X-version messages 302. Consequently, an average (e.g., a baseline) can be obtained for performance data relating to performance indicator 306-1, an average (e.g., a baseline) can be obtained for performance data relating to performance indicator 306-2, and so on. In some embodiments, the server system excludes performance data relating to a performance indicator when the performance data is an outlier.

As shown, the Y-version message 304 includes a plurality of performance indicators (e.g., performance indicators 308-1, 308-2, 308-3, . . . 308-n). Each performance indicator is associated with an application program of the application. For example, performance indicator 308-1 may correspond to a video streaming program of the application. Furthermore, each performance indicator includes performance data for its application program. For example, performance indicator 308-1 may include performance data for the video streaming program in the application.

In some embodiments, the performance indicators 308-1, 308-2, 308-3, . . . 308-n are averages determined from multiple Y-version messages 304. As stated above, the server system may average performance data relating to each performance indicator (e.g., performance indicators 308-1, 308-2, 308-3, . . . 308-n) received in multiple Y-version messages 304. Consequently, an average can be obtained for performance data relating to performance indicator 308-1, an average can be obtained for performance data relating to performance indicator 308-2, and so on.

As described above, performance indicator 306-1 and performance indicator 308-1 both include performance data for video streaming, albeit for different versions of the application (e.g., performance indicator 306-1 includes video streaming performance data for X-version of the application while performance indicator 308-1 includes video streaming performance data for Y-version of the application). Performance indicators 306-1, 308-1 may form a respective pair of performance indicators 309.

The server system 200 may perform one or more comparison operations 310-1, 310-2, 310-3, . . . 310-n. (e.g., compare one or more respective pairs of performance indicators). Put another away, the server system compares a respective performance indicator (e.g., performance indicator 308-1) against the baseline established for performance indicator 306-1. In the event that the respective performance indicator deviates from the baseline established for performance indicator 306-1 by a threshold amount, the respective performance indicator may be provided in a report. In some embodiments, the server system may provide the results from each compare operation in the report. In some embodiments, the server system may provide one or more results from one or more compare operations in the report. In some embodiments, the calculated averages for each of the performance indicators are normalized. In this way, a single baseline (e.g., baseline 403, FIG. 4) may be formed and displayed in the report. In some embodiments, the calculated averages for the performance indicators 308-1, 308-2, 308-3 are normalized. In some embodiments, the calculated averages for the performance indicators 306-1, 306-2, 306-3 are normalized.

FIG. 4 is an illustration of a report provided by the server system, in accordance with some embodiments. In particular, a dashboard 401 may be provided by the server system in response to a determination that one or more respective performance indicators (e.g., performance indicators 308-1 and 308-2) satisfy a threshold value (e.g., comparison operations 310-1, 310-2, 310-3, . . . 310-n). As shown, performance indicators 308-1, 308-2, and 308-3 are included in the dashboard 401. Performance indicator 308-3 generally would not be included in the dashboard 401 because the degree of difference 410 (e.g., deviation from baseline 403) does not exceed the corresponding threshold 412. However, for illustrative purposes, performance indicator 308-3 is included in dashboard 401.

The server system may include a performance indicator in the dashboard when a difference (e.g., difference 402) determined during a comparison operation (e.g., comparison operations 310-1, 310-2, 310-3, . . . 310-n) between performance indicators (e.g., performance indicators 306-1, 308-1) satisfies a threshold (e.g., threshold 404). In some embodiments, the difference determined during the comparison operation may be the difference between the determined averages as discussed above. In some embodiments, the difference determined during the comparison operation may be the difference between a number of X-version performance indicators and a number of Y-version performance indicators. As shown, performance indicator 308-1 is provided in the dashboard 401 because a difference 402 determined during comparison operation 310-1 between performance indicator 308-1 and performance indicator 306-1 satisfied the threshold 404. As discussed above, comparison operation 310-1 compared performance data of performance indicator 306-1 with performance data of performance indicator 308-1. Column 402 represents the difference (e.g., deviation from the baseline) between the performance indicator 306-1 (e.g., first version or X-version) and performance indicator 308-1 (e.g., second version or Y-version). The server system also included performance indicator 308-2 in the dashboard 401 because a difference 406 determined during comparison operation 310-2 between performance indicator 308-2 and performance indicator 306-2 satisfied a threshold 408.

From X-version to Y-version, there may exist a permissible degree of difference (e.g., also referred to herein as thresholds) for respective application programs. In other words, a performance indicator for a second version of the application may deviate from a respective baseline by an amount. The server system may set thresholds (e.g., thresholds 404, 408, 412) according to: (1) performance data received from a previous version of the application (e.g., performance data for X-version of the application), and (2) expected differences between the previous version (e.g., X-version) of the application and the updated version (e.g., Y-version) of the application resulting from one or more changes in the updated version of the application. For example, developers modify program code for application programs (e.g., video streaming program) to a degree when updating the various application programs. Assuming the code executes properly, an anticipated degree of difference between a previous version application program and an updated version application program will exist. As shown in FIG. 4, the performance indicators 308-1, 308-2, 308-3 each have a permissible degree of difference 404, 408, 412, respectively (e.g., performance indicator 308-3 is permitted to deviate, say, 20%, from the baseline 403 established for performance indicator 306-3).

As shown in FIG. 4, the thresholds 404, 408, and 412 may vary by performance indicator. In some embodiments, the server system may permit greater variance among the thresholds 404, 408, 412 because certain application programs have greater expected differences between versions. The permitted variance for thresholds thus may be directly correlated with expected differences between versions. In some embodiments, the greater expected difference results from one or more changes in the updated (e.g., new) version of the application. In some embodiments, the greater expected difference results from the type of application program (e.g., video streaming program may have a greater allowable variance between versions versus, say, a message sending program). In some embodiments, the greater expected differences may result from a location of client devices using the application. It should be noted that the “% Difference” are merely illustrative and may not reflect permitted thresholds.

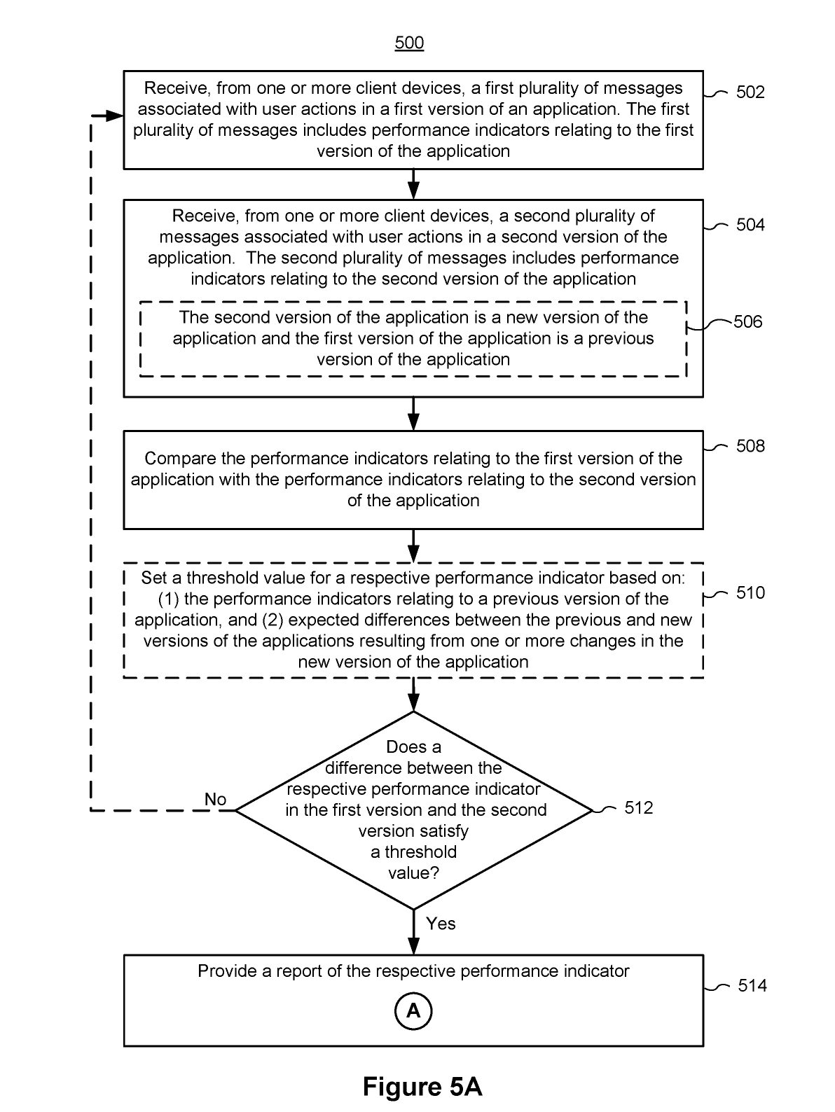

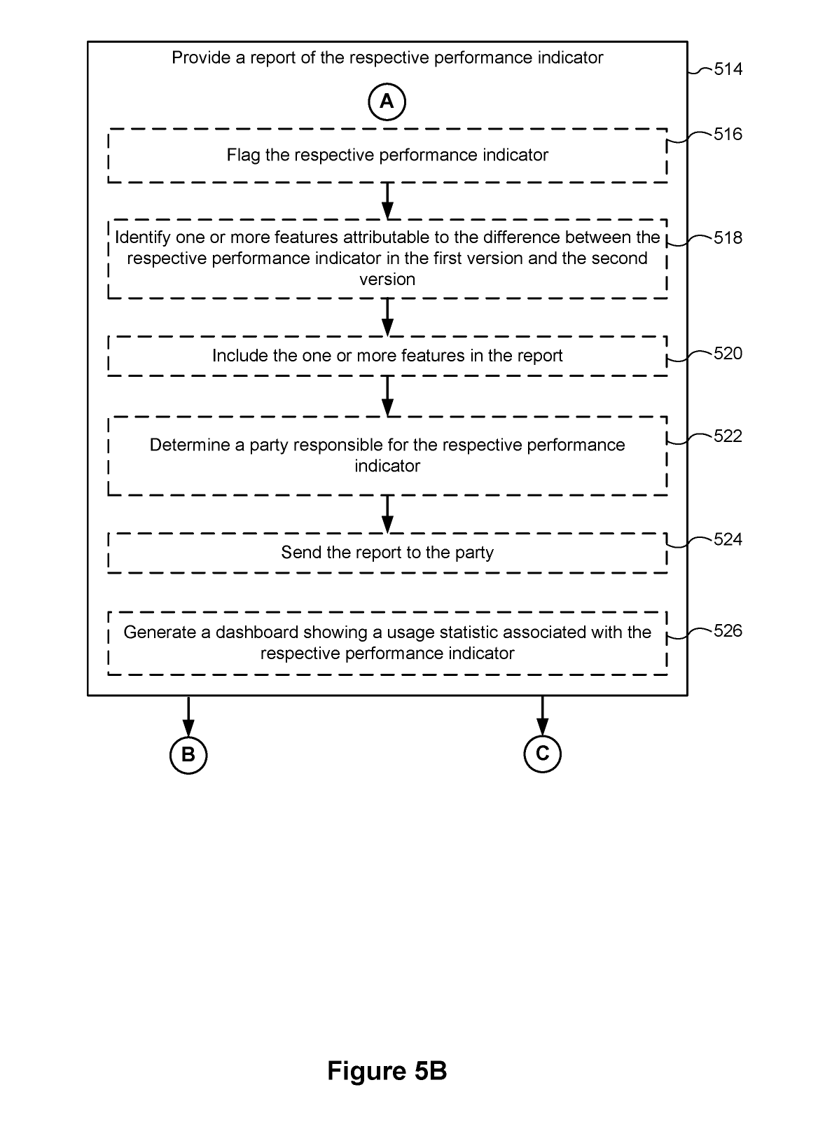

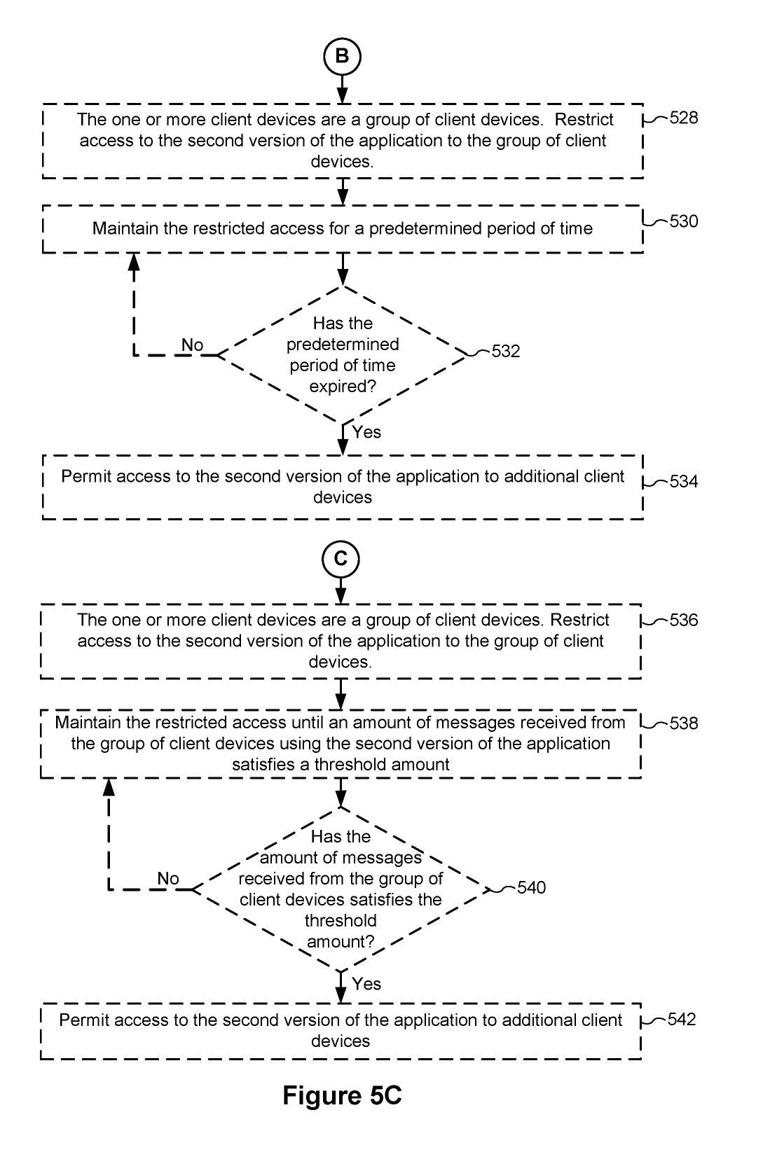

FIGS. 5A-5C are flow diagrams illustrating a method of comparing messages from two versions of an application, in accordance with some embodiments. In some embodiments, the method 500 is performed by a server system (e.g., social network system 108, FIG. 1). FIGS. 5A-5C correspond to instructions stored in a computer memory or computer readable storage medium (e.g., memory 206 of the social network system 108 and/or memory 306 of the client device 104).

For ease of explanation, the following describes method 500 as performed by a server system (e.g., by server system 200, FIG. 2). With reference to FIG. 2, in some embodiments, the operations of method 500 are performed, at least in part, by a communications module (e.g., communications module 212, FIG. 2), and a reporting module (e.g., reporting module 220, FIG. 2). As shown in FIG. 2, the reporting module 220 may include a compare module (e.g., compare module 226, FIG. 2), a flag module (e.g., flag module 228, FIG. 2), and a restriction module (e.g., restriction module 230, FIG. 2).

The method begins when the server system (e.g., social network system 108, FIG. 1), receives (502) from one or more client devices (e.g., client devices 104-1, 104-2, . . . 104-n, FIG. 1), a first plurality of messages associated with user actions (e.g., user 102-1, 102-2, . . . 102-n, FIG. 1) in a first version of an application. The server system receives the messages from the one or more client devices via a network (e.g., networks 106, FIG. 1). In some embodiments, the first version of the application may be a previously released version of the application. In some embodiments, the first version of the application may be a test and/or competing version of the application. In some embodiments, the application may be a social media application (e.g., Facebook social networking application executing on each of the one or more client devices).

The server system receives (504) from one or more client devices, a second plurality of messages associated with user actions in a second version of the application. The second version of the application may be more recent than the first version (e.g., a previous version) of the application (506). In some embodiments, the second version of the application is an updated (e.g., new) version of a previous version of the application. For example, the second version may include one or more updates to various application programs. In some embodiments, the second version of the application may be a test and/or competing version of the application.

In some embodiments, the one or more client devices associated with the second plurality of messages are the same one or more client devices associated with the first plurality of messages. For example, the server system may be configured to receive messages from a specific group of client devices, regardless of the version of the application executing on the one or more client devices.

In some embodiments, the one or more client devices associated with the second plurality of messages may be different from the one or more client devices associated with the first plurality of messages. For example, the one or more client devices associated with the second plurality of messages may be may be testing a newly released version (e.g., an updated version) of the application. Consequently, in this particular example, the one or more client devices associated with the second plurality of messages may be client devices of a limited number of users of the application.

In some circumstances or situations, client devices using the second version of the application may differ from the client devices using the first version of the application. For example, the client devices using the second version of the application may be located in a developing country while the client devices using the first version of the application may be located in a developed country. As such, the client devices using the second version of the application may be older model client devices and may also be operating on slower networks (e.g., second generation wireless (2G)). The difference between client devices may result in signs of performance issues with the second version of application when in fact the second version of the application is functioning properly. Consequently, in some embodiments, the second plurality of messages may be normalized using one or more normalization factors. In some embodiments, the first plurality of messages may be normalized using one or more normalization factors. In some embodiments, the first and second pluralities of messages may be normalized using one or more normalization factors. The one or more normalization factors may minimize (e.g., negate) false signs of performance issues in received messages caused by client devices using the second version of the application in a different location.

The first and second pluralities of messages may include performance indicators relating to the first and second versions of the application, respectively. A performance indicator may include performance data (also referred to herein as usage statistics) relating to specific application programs. In some embodiments, the performance indicators may include data relating to failure(s) of a respective application program (e.g., failure of one of the application's programs). For example, if an application program fails to properly run, then the received performance indicator may signal that failure. An application includes many specific application programs, such as video streaming, receiving messages, sending messages, generating relevant news articles, and the like. As such, in some embodiments, each message (e.g., X-version message 302 and/or Y-version message 304) received may include performance data for multiple programs. Furthermore, in some embodiments, the performance indicators may include other relevant data such as IP addresses of the one or more clients, application version, application type (e.g., iOS, Android, and the like), and other data (e.g., wireless speed and/or device model).

As stated above, the first plurality of messages may include messages associated with the first version (e.g., a previous version) of the application. As such, the first plurality of messages may include performance data for the specific application programs for the first version. In some embodiments, the server system may store (e.g., in memory 206, FIG. 2) the first plurality of messages. In some embodiments, the server system may update a table of values with the first plurality of messages. In some embodiments, the server system may continue to store messages until it receives a threshold number of messages for the previous version of the application (e.g., stored X-number of the first plurality of messages). For example, the threshold number of messages may be determined based on the number of messages required to obtain performance data for each of the programs of the software application. In some embodiments, the first plurality of messages may be received from a predefined group of client devices (e.g., a test group or beta group of users). Alternatively, in some embodiments, the first plurality of messages may be received from client devices without restriction.

The second plurality of messages may include performance data for the specific application programs for the second version of the application. In some embodiments, the specific application programs of the second version of the application may be the same or substantially similar to the application programs for the first version of the application. In some embodiments, one or more application programs of the second version of the application differ from the application programs of the first version of the application. For example, one or more programs of the second version of the application may have features (e.g., new features) not included in previous versions of the application.

In some embodiments, the server system may store the second plurality of messages in memory (e.g., memory 206, FIG. 2). In some embodiments, the server system may update a table of values with the second plurality of messages. In some embodiments, the server system may receive messages for a period of time prior to performing a compare operation (508) discussed below. For example, the server system may receive messages for the second version of the application from the one or more client devices for a week before performing a compare operation.

The server system may compare (508) the performance indicators relating to the first version of the application with the performance indicators relating to the second version of the application. For example, the server system may compare a first performance indicator relating to the first version of the application with a corresponding first performance indicator relating to the second version of the application, and so on (e.g., as shown in FIG. 3, each comparison operation may involve comparing corresponding performance indicators, such as performance indicator 306-1 and performance indicator 308-1, performance indicator 306-2 and performance indicator 308-2, and so on). As discussed above with reference to FIG. 3, performance indicator 306-1 and performance indicator 308-1 may include performance data for a similar (if not the same) application program.

In some embodiments, the server system may compare performance indicators individually or may compare groups of performance indicators. In some embodiments, the server system may compute average values (e.g., establishes a baseline) and subsequently may compare averages relating to the first version of the application with the averages relating to the second version of the application. The server system may compute the average by first receiving N-number of messages over a period of time for the first version of the application. Each received message may include a plurality of performance indicators (e.g., a performance indictor for program-1, a performance indicator for program-2, and so on). Next, the server system may separate the message and form groups of performance indicators for the first version of the application. For example, a first group of performance indicators may include performance data for program-1, a second group of performance indicators may include performance data for program-2, and so on. Thereafter, the server system may establish a baseline for a given performance indicator by calculating the average value of the performance data found in a given group (e.g., a first group of performance indicators includes performance data from K-number of messages). In some embodiments, the server system may calculate an average for a given performance indicator after a threshold amount of messages are received. Furthermore, in some embodiments, the server system, after receiving the threshold amount of messages, may recalculate the averages at predetermined intervals. For example, the server system may recalculate the average every day. In this way, data from newly received messages over the previous day, for example, can be taken into account when calculating the averages.

In some embodiments, the server system may set (510) a threshold which establishes a permissible degree of deviation from a baseline (e.g., a calculated average). The threshold for a respective performance indicator may be based on: (1) the performance indicators relating to a previous version of the application (e.g., based on an average value, e.g., the established baseline), and (2) expected differences between the previous and updated (e.g., new) versions of the applications resulting from one or more changes in the updated version of the application (e.g., anticipated deviation from the baseline based on the one or more changes). In some embodiments, the server system may set a plurality of threshold values (e.g., a threshold value is set for each respective performance indicator). The threshold values for each respective performance indicator can differ based on the type of application program. In circumstances where the updated version of the application includes one or more new features (e.g., programs) (as opposed to one or more changes to existing features), then the threshold value may be based on the expected differences resulting from one or more new features in the updated version of the application.

In some embodiments, in response to a determination that a difference between a respective performance indicator in the first version and the second version of the application does not satisfy a threshold value (512—No), the server system may restart method 500. For example, the server system may receive additional first plurality of messages associated with user actions in the first version of the application and may receive additional second plurality of messages associated with user actions in the second version of the application. In certain circumstances of this example, the server system may wait for a period of time (e.g., an hour, a day, or a week) or until a threshold amount of first and/or second pluralities of messages are received before performing another compare operation (508) after restarting method 500. In some circumstances, the server system can no longer receive additional messages for a first version of the application (e.g., the first version is not widely used). In such circumstances, the server system may receive additional second plurality of messages and not receive additional first plurality of messages.

In some embodiments, in response to a determination that a difference between a respective performance indicator in the first version and the second version of the application does not satisfy a threshold value (512—No), the server system may provide a report indicating that no respective performance indicator of the second version of the application satisfied a threshold value (not shown). In such a situation, the report may indicate that the second version of the application is executing properly on the one or more client devices.

The server system, in response to a determination that a difference between a respective performance indicator (e.g., the same performance indicator) in the first version and the second version of the application satisfies a threshold value (512—Yes), may provide (514) a report of the respective performance indicator. In some embodiments, the servers system may provide the report to a developer of the application. For example, the server system may provide the report to a social media platform. In some embodiments, when providing the report, the server system may flag (516) the respective performance indicator (e.g., flags each performance indicator that satisfies the threshold). In some embodiments, flagging the respective performance indicator may include adding the respecting performance indicator to a list. The list can include each performance indicator provided in the report.

In some embodiments, the server system may identify (518) one or more features attributable to the difference between the respective performance indicator in the first version and the second version (e.g., identifies one or more causes for the substantial deviation from the baseline). For example, the server system may identify one or more portions of the program code that led to the respective performance indicator being provided in the report. In some embodiments, the server system may analyze information associated with the client devices that sent the messages to the server system. For example, the server system may analyze location data and service provider data associated with the client devices. In situations where the one or more features attributable to the difference between the respective performance indicator in the first version and the second version results from a location of the second plurality of messages (e.g., located in a developing country), the server system may normalize the performance indicators in the first and/or second pluralities of messages using one or more normalization factors. The one or more normalization factors may normalize for factors such as client device model and/or size, network type (e.g., second generation wireless (2G)), and the like.

In some embodiments, the server system may include (520) the one or more identified features in the report. For example, the report may include the one or more portions of the program code that led to the respective performance indicator being provided in the report. In this way, the developer of the application may be notified of the issue associated with the second version of the application.

In some embodiments, the server system may determine (522) a party responsible for the respective performance indicator. For example, if the respective performance indicator is associated with a picture upload program in the second version of the application, then the server system may identify a person (or group of people or department) responsible for the picture upload program. Accordingly, providing the report may include sending (524) the report to the responsible party. In this way, the responsible party may quickly become aware of the performance of the code for which that are responsible.

In some embodiments, the server system may generate (526) a dashboard showing a usage statistic (e.g., performance data) associated with the respective performance indicator. As shown in FIG. 4, the server system may include a performance indicator (e.g., performance indicators 308-1, 308-2) in the dashboard 401 when a difference determined during a comparison operation (e.g., comparison operations 310-1, 310-2, 310-3, . . . 310-n or compare operation 508) between performance indicators (e.g., performance indicators 306-1, 308-1) satisfies a threshold (e.g., threshold 404). The dashboard 401 provided in FIG. 4 is one of many types of possible dashboards.

The method 500 may continue, in some embodiments, the server system may restrict (528) access to the second version (e.g., a more recent, updated version) of the application to a group of client devices. In some embodiments, the one or more client devices associated with the second version of the application may be the group of client devices. Access may be restricted to the group of client devices so that the group of client devices can test the second version of the application. As such, in some embodiments, the server system may maintain (530) the restricted access for a predetermined period of time so that the second version of the application can be adequately tested by the group of client devices. In some embodiments, the second version of the application may be adequately tested when the group of client devices executes each program in the second version of the application a predetermined number of times. For example, the second version of the application may be deemed to be adequately tested when the group of client devices executes each program in the second version at least once. Alternatively, in some embodiments, the predetermined period of time may correspond to a period of time required to receive a threshold amount of messages (see discussion below).

In some embodiments, in response to an expiration of the period of time (532—Yes), the server system may permit (534) access to the second version of the application to additional client devices. In some embodiments, permitting access to additional client devices may include permitting access to client devices without restriction. In some embodiments, permitting access to additional client devices may include permitting access to client devices in a geographic area (e.g., client devices located in country Y may now access the second version of the application whereas before the expiration of the period of time only client devices located in country Y that were part of the group of client devices could access the second version of the application). In some embodiments, permitting access to additional client devices may include permitting access to client devices on a certain network (e.g., client devices on network X may now access the second version of the application whereas before the expiration of the period of time only client devices on network X that were part of the group of client devices could access the second version of the application).

Alternatively, in some embodiments, the server system may restrict (536) access to the second version of the application to the group of client devices and maintain (538) the restricted access until an amount of messages received from the group of client devices using the second version of the application satisfies a threshold amount. The threshold amount of messages may be the number of messages required to adequately test each aspect (e.g., each program) of the second version of the application. In some circumstances, the threshold amount of messages may vary from version to version of the application. For example, one updated version of the application may have changed little when compared to a previous version, and as a result the threshold amount of messages to test each aspect of the version may be minimal relative to the amount of messages required to test previous versions. On the other hand, another updated version of the application may include numerous updates when compared to a previous version, and therefore the threshold amount of message would be substantial in order to test each aspect of the updated version relative to the previous version.

The server system, in response to the amount of messages received from the group of client devices satisfying the threshold amount (540—Yes), may permit (542) access to the second version of the application to additional client devices. In some embodiments, permitting access to additional client devices may include permitting access to client devices without restriction. In some embodiments, permitting access to additional client devices may include permitting access to client devices in a geographic area (e.g., client devices located in country Y may now access the second version of the application whereas before the expiration of the period of time only client devices located in country Y that were part of the group of client devices could access the second version of the application). In some embodiments, permitting access to additional client devices may include permitting access to client devices on a certain network (e.g., client devices on network X may now access the second version of the application whereas before the expiration of the period of time only client devices on network X that were part of the group of client devices could access the second version of the application).

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at a server system having one or more processors and memory storing instructions for execution by the one or more processors:
receiving, from one or more client devices, a first plurality of messages associated with user actions in a first version of an application, wherein the first plurality of messages includes performance indicators relating to the first version of the application;
receiving, from one or more client devices, a second plurality of messages associated with user actions in a second version of an application, wherein the second plurality of messages includes performance indicators relating to the second version of the application and the second version of the application is more recent than the first version of the application;
comparing the performance indicators relating to the first version of the application with the performance indicators relating to the second version of the application; and
in response to a determination that a difference between a respective performance indicator in the first version and the second version satisfies a threshold value, providing a report of the respective performance indicator.

2. The method of claim 1, wherein the second version of the application is a new version of the application and the first version of the application is a previous version of the application.

3. The method of claim 2, wherein the new version of the application includes one or more changes.

4. The method of claim 3, further comprising setting the threshold value for the respective performance indicator based on: (1) the performance indicators relating to the previous version of the application and (2) expected differences between the previous and new versions of the applications resulting from the one or more changes in the new version of the application.

5. The method of claim 3, further comprising setting respective threshold values for the performance indicators relating to the first and second versions of the application based on: (1) the performance indicators relating to the previous version of the application and (2) expected differences between the previous and new versions of the applications resulting from the one or more changes in the new version of the application.

6. The method of claim 1, wherein providing the report comprises:
flagging the respective performance indicator in response to the determination;
identifying one or more features attributable to the difference between the respective performance indicator in the first version and the second version; and
including the one or more features in the report.

7. The method of claim 6, wherein providing the report further comprises:
determining a party responsible for the respective performance indicator; and
sending the report to the party.

8. The method of claim 7, wherein providing the report further comprises generating a dashboard showing a usage statistic associated with the respective performance indicator.

9. The method of claim 1, wherein the performance indicators include data relating to failures of the application.

10. The method of claim 9, wherein the performance indicators include IP addresses of the one or more clients.

11. The method of claim 1, wherein the one or more client devices are a group of client devices, and the method further comprises:
restricting access to the second version of the application to the group of client devices; and
maintaining the restricted access for a predetermined period of time.

12. The method of claim 11, further comprising:
in response to a determination that the predetermined period of time has expired, permitting access to the second version of the application to additional client devices.

13. The method of claim 1, wherein the one or more client devices are a group of client devices, and the method further comprises:
restricting access to the second version of the application to the group of client devices; and
maintaining the restricted access until an amount of messages received from the group of client devices using the second version of the application satisfies a threshold amount.

14. The method of claim 13, further comprising:
in response to a determination that the amount of messages received from the group of client devices satisfies the threshold amount, permitting access to the second version of the application to additional client devices.

15. A server system, comprising:
a processor; and
memory storing one or more programs for execution by the processor, the one or more programs including instructions for:
receiving, from one or more client devices, a first plurality of messages associated with user actions in a first version of an application, wherein the first plurality of messages includes performance indicators relating to the first version of the application;
receiving, from one or more client devices, a second plurality of messages associated with user actions in a second version of an application, wherein the second plurality of messages includes performance indicators relating to the second version of the application and the second version of the application is more recent than the first version of the application;
comparing the performance indicators relating to the first version of the application with the performance indicators relating to the second version of the application; and
in response to a determination that a difference between a respective performance indicator in the first version and the second version satisfies a threshold value, providing a report of the respective performance indicator.

16. The system of claim 15, wherein the second version of the application is a new version of the application and the first version of the application is a previous version of the application.

17. The system of claim 15, wherein providing the report comprises:
flagging the respective performance indicator in response to the determination;
identifying one or more features attributable to the difference between the respective performance indicator in the first version and the second version; and
including the one or more features in the report.

18. The system of claim 17, wherein providing the report further comprises:
determining a party responsible for the respective performance indicator; and
sending the report to the party.

19. The system of claim 15, wherein providing the report further comprises generating a dashboard showing a usage statistic associated with the respective performance indicator.

20. A non-transitory computer-readable storage medium, storing one or more programs configured for execution by one or more processors of a server system, the one or more programs including instructions, which when executed by the one or more processors cause the server system to:
receive, from one or more client devices, a first plurality of messages associated with user actions in a first version of an application, wherein the first plurality of messages includes performance indicators relating to the first version of the application;
receive, from one or more client devices, a second plurality of messages associated with user actions in a second version of an application, wherein the second plurality of messages includes performance indicators relating to the second version of the application and the second version of the application is more recent than the first version of the application;
compare the performance indicators relating to the first version of the application with the performance indicators relating to the second version of the application; and
in response to a determination that a difference between a respective performance indicator in the first version and the second version satisfies a threshold value, provide a report of the respective performance indicator.
